(19) United States
(12) Patent Application Publication
(10) Pub. No.: US 2005/0114883 A1
(43) Pub. Date: May 26, 2005

(54) Information providing method, information providing apparatus, and computer-readable recording medium with information providing program recorded thereon

(76) Inventors: Satoshi Nagai, Kawasaki (JP); Toshihiro Kodaka, Yokohama (JP); Hirokazu Hanno, Chiba (JP); Takashi Kurihara, Koshigaya (JP); Mitsuru Nakajima, Zama (JP)

Correspondence Address: SWIDLER BERLIN LLP, 3000 K STREET, NW, BOX IP, WASHINGTON, DC, 20007, US

(21) Appl. No.: 10/853,278

(22) Filed: May 26, 2004

(30) Foreign Application Priority Data
Nov. 25, 2003 (JP) 2003-393552

(51) Int. Cl. H04N 7/173; H04N 7/10; H04N 7/025

(52) U.S. Cl. 725/34; 725/35

(57) ABSTRACT

An information providing method includes the steps of receiving pieces of terminal identifying information and pieces of user identifying information from a plurality of terminal devices, identifying user attributes for each of the pieces of user identifying information by referring to a user management table containing correspondences between the user identifying information and user attributes, by referring to an information management table containing correspondences among user attributes, provided information, and related information, extracting pieces of provided information and pieces of related information for each of the user attributes, outputting, for each of the pieces of user identifying information, the extracted provided information to terminal devices identified by corresponding pieces of the terminal identifying information, and displaying the extracted related information on a screen of a screen device.

### BACKGROUND OF THE INVENTION

1. Field of the Invention

The present invention relates to an information providing method and apparatus which output mutually related pieces of information to both a terminal device for outputting information and a display device for displaying information on a screen.

2. Description of the Related Art

By way of example, in the banking industry in Japan, based on the recent deregulation on banks' side business, it is predicted that it will become possible to display an advertisement on the screen of an automatic teller machine (ATM) terminal that allows a bank customer to perform his or her banking transactions, such as withdrawing, depositing, and transferring, by using an ATM card or a passbook, and that technology for advertising on a balance slip printed by an ATM terminal will be developed. (See, for example, Eiri OSAWA, Nomura Research Institute, Ltd., “Ginko-no Kengyou-kisei-kanwa-niyoru Joho-shisutemu-shisan-no Tenbo (Prospects for information-system resource utilization based on deregulation on banks' side business)” [online document retrieved on Oct. 30th 2003], Jul. 11th 2003, “NIKKEI NET BizPlus”, “IT solution frontier”, URL: http://bizplus.Nikkei.co.jp/genre/it/media/index.cfm?i=i%5fn ri060.)

Also, there is a disclosed technology (See, for example, Japanese Utility Model Registration Publication No. 3078037) in which a transaction type and amount for a user, and award information in accordance with the attribute of the user, are retrieved from a database and are printed on a balance slip output by an ATM terminal.

Not only in the banking industry but also in the retailing business, there is a similar technology in which, by using a point-of-sale (POS) terminal, coupon information is printed on a receipt. (See, for example, Shin-ichi MAEDA, Andrometec Co., Ltd., “No. 1 96/3/6 Netto-wakingu&LAN-keburu (Networking & LAN Cable)” [online document retrieved on Oct. 30th 2003], Mar. 6th 1996, URL: http://www.andrometec.com/maeda/dm19960306.htm.)

In the related art, coupon information or an advertisement is printed on a receipt or balance slip issued by a machine such as an ATM terminal or POS terminal. The receipt or balance slip has a limited blank space in which related information, such as the coupon information, can be printed since the paper used for the receipt or balance slip is generally small.

For example, although coupon information, and the address, or the like, of a store in which the coupon information is usable can be printed, it is impossible to print content which requires some printing space for a detailed description of the goods covered and a location map of the store. Accordingly, with only the coupon information, the user (consumer) cannot know details of the goods covered and the location of the store, so that a problem occurs in that incentive for the user to use the coupon information is not enhanced.

Also, in the related art, advertising information is displayed only for users who use ATM terminals and POS terminals. Advertisers who provide coupon information and advertising information would like to inform more users of both types of information.

However, for an example of the related art which provides advertisement matching attributes (See, for example, sex, age, hobby, etc.) of each user, it is difficult to sufficiently satisfy the above hope of the advertiser. In other words, this is because, even if some attributes of a user match the attributes in an advertisement displayed by the ATM or POS terminal, also other advertisements having similar attributes actually exist.

In the related art, from among possible advertisements matching user attributes, one or more are selected. In this case, to a user having user attributes, a particular matching advertisement is not always provided. Accordingly, provision of advertising information suited for the advertiser becomes difficult.

Also, to solve the above two problems, it must be considered that there is not a single ATM or POS terminal but a plurality of ATM or POS terminals in a single store. In the case of displaying, not only to users who must be notified, but also to display devices which other users can view, related information which relates to advertising information output to the terminals, the other users will simply recognize the related information as random advertisements if the advertising information and the related information do not have any mutual relationship.

Conversely, if advertising information is simply selected with user attributes used as a reference, pieces of information displayed on display devices for users who must be notified and for other users cannot be allowed to have some relationship.

In addition, since there are ATM or POS terminals in a single store, when the display devices are controlled to sequentially display the related information of the advertising information, one user (i.e., a user to be provided with advertising information) who uses one terminal must wait until advertising information necessary for that user is displayed.

### SUMMARY OF THE INVENTION

It is an object of the present invention to provide users with information valuable to them and to efficiently display related information concerning a plurality of pieces of advertising information which are output to a plurality of terminals.

According to an aspect of the present invention, an information providing method is provided which includes the steps of: by a computer, receiving pieces of terminal identifying information and pieces of user identifying information from a plurality of terminal devices (e.g., ATM terminal devices, etc.); identifying user attributes for each of the pieces of user identifying information by referring to a user management table containing correspondences between the user identifying information and user attributes; by referring to an information management table containing correspondences among user attributes, providing information, and related information, extracting pieces of providing information and pieces of related information for each of the user attributes; outputting, for each of the pieces of user identifying information, the extracted providing information to terminal devices identified by corresponding pieces of the terminal identifying information; and displaying the extracted related information on a screen of a screen device.

In the information providing method of the present invention, when the providing information is extracted, based on assumption information which is used as a condition on providing information search and which is displayed beforehand on the screen of the display device, the providing information may be narrowed down.

In the information providing method of the present invention, among the extracted pieces of related information, at least two pieces of the related information may be simultaneously displayed on the screen of the display device.

The present invention enables provision of information which is valuable to users and which increases use of printed advertising information, and enables the content of the printed advertising information to be displayed for users other than users whose requests are being processed.

### BRIEF DESCRIPTION OF THE DRAWINGS

FIG. 1 is a block diagram showing an example of the entire system according to a first embodiment of the present invention;

FIG. 2 is a flowchart showing basic processes in the first embodiment of the present invention;

FIG. 3 is a flowchart showing overall processing in a case in which two terminals in the first embodiment of the present invention mutually perform processes;

FIG. 4 is a flowchart showing an advertisement selecting routine in the first embodiment of the present invention;

FIG. 5 is a flowchart showing a displayed color selecting routine in the first embodiment of the present invention;

FIG. 6 is an illustration of an example of a screen table;

FIG. 7 is an illustration of an example of a balance table;

FIG. 8 is an illustration of an example of an advertisement management table;

FIG. 9 is an illustration of an example of a personal information table;

FIG. 10 is an illustration of an example of a terminal management table;

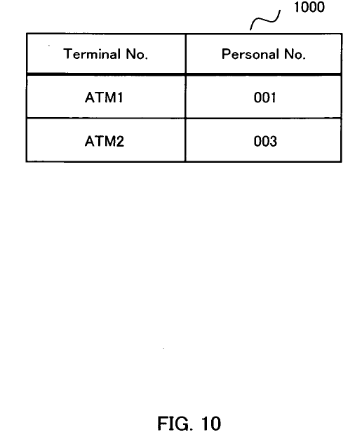

FIG. 11 is an illustration of an example of a delivery record table;

FIGS. 12A and 12B are illustrations of examples of possible users in an advertisement selecting process;

FIG. 13 is an illustration of an example of a screen display table;

FIG. 14 is an illustration of an example of a balance slip output from an ATM terminal;

FIG. 15 is an illustration of an example of a map-displayed screen;

FIGS. 16A and 16B are illustrations of an example of a screen table and an example of an advertisement management table in a second embodiment of the present invention;

FIG. 17 is an illustration of a categorized display screen in the second embodiment of the present invention; and

FIGS. 18A and 18B are illustrations of an example of a screen table and an example of an advertisement management table in a third embodiment of the present invention.

### DESCRIPTION OF THE PREFERRED EMBODIMENTS

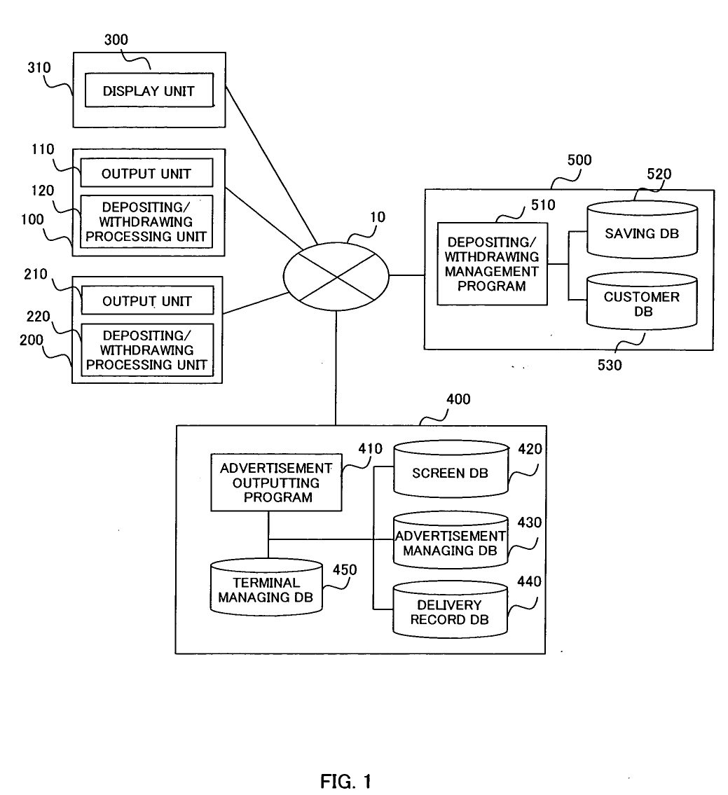

FIG. 1 shows the configuration of the entirety of a system according to a first embodiment of the present invention.

The system includes a network circuit 10, terminals 100 and 200, a display device 300, an advertising processor 400, and a banking processor 500.

The network circuit 10 may be either a network limited to a certain range, such as an in-house local-area network, or an open network which is open to the public, such as the Internet or a telephone network, if it can treat digital data. Also, the network circuit 10 may be either wired or wireless.

The terminals 100 and 200 include output units 110 and 210, depositing/withdrawing processing units 120 and 220, respectively. Each of the output units 110 and 210 outputs, as printed form or data, a banking-processed result transmitted from the banking processor 500, or advertising information transmitted from the advertising processor 400. Each of the depositing/withdrawing processing units 120 and 220 transmits terminal identifying information and user identifying information concerning a user to the advertising processor 400 and the banking processor 500, and executes consecutive processing concerning depositing and withdrawing, such as displaying of information on a display screen provided to a terminal, acceptance of money, and withdrawing, by exchanging the information required for disbursement, etc., with the banking processor 500.

The display device 300 includes a display unit 310. The display unit 310 receives screen information transmitted from the advertising processor 400 and displays the received information on its display screen.

The advertising processor 400 further includes an advertisement outputting program 410, a screen database 420, an advertisement managing database 430, a delivery record database 440, and a terminal managing database 450.

The advertisement outputting program 410 performs selection of an advertisement to be output to the terminal 100 and/or the terminal 200 and commanding of output of the advertisement, and creation of screen information to be displayed on the display device 300 and commanding of output of the screen information.

The screen database 420 stores various types of advertisement to be printed by the terminals 100 and 200, various types of screen data to be displayed on the display device 300, and various tables (screen table 600, screen display table 1200) for managing screens displayed on the display device 200.

The advertisement managing database 430 stores an advertisement managing table 800 for managing advertising information, related information concerning advertisement, attributes of users to be notified of advertisement, etc.

The delivery record database 440 stores a delivery record table 1100 in which a history about when the advertising information output to the terminals 100 and 200 is provided to which user.

The terminal managing database 450 stores a terminal managing table 1000 that manages pieces of terminal identifying information assigned to terminals and pieces of user identifying information assigned to users who are using the terminals so as to be associated with each other.

The banking processor 500 further includes a depositing/withdrawing management program 510, a saving database 520, and a customer database 530.

The depositing/withdrawing management program 510 executes consecutive processing concerning depositing/withdrawing in banking business. The saving database 520 stores an outstanding balance table 700 for managing a balance in account of each user. The customer database 530 stores a personal information table 900 in which various types of user attribute information, such as user identifying information, an authentication password, name, address, sex, age, and hobbies of each user, are managed so that they are associated with one another.

The banking processor 500 can include the program or various databases included in the advertising processor 400. The display device 300 may include an output unit for outputting a displayed screen in printed form or in data form.

In this system configuration, only the functions of depositing/withdrawing processing in banking business are shown. However, other banking processing can replace the depositing/withdrawing processing.

The shown system configuration is not limited to the banking business. It can be applied to any type of business in which a processing result is output when a user purchases goods or completes settlement. In the case of applying this system to purchasing results, the banking processor 500 becomes a sales management apparatus including the customer database 530, and does not need the depositing/withdrawing management program 510 and the saving database 520.

First Embodiment

In a first embodiment of the present invention, an application of the present invention to in-bank depositing/withdrawing is described below by using consecutive processing in which coupon information matching user's attributes is printed on a balance slip issued by an ATM terminal, and the locations of stores in which the printed coupon information can be indicated on a map displayed beforehand on a display device installed beside the ATM terminal.

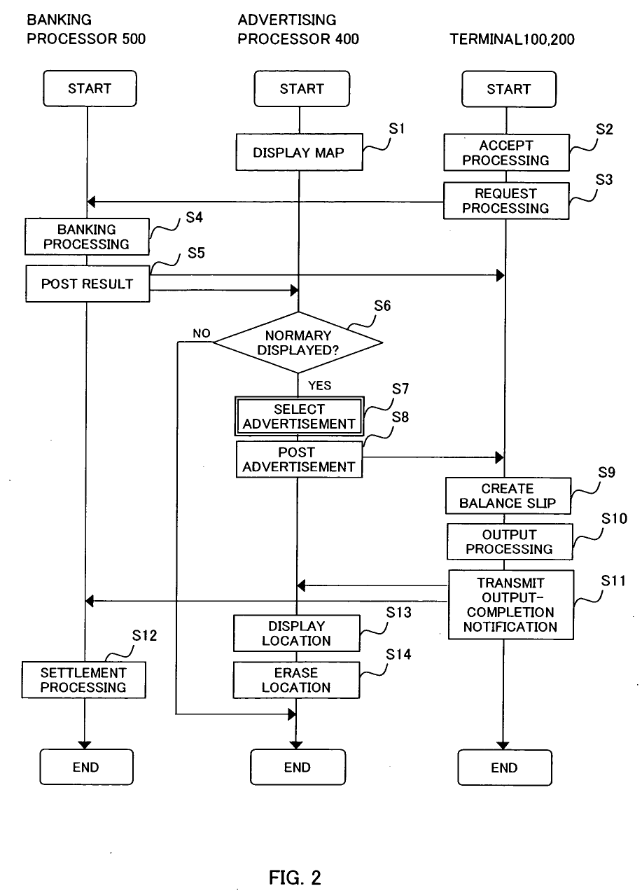

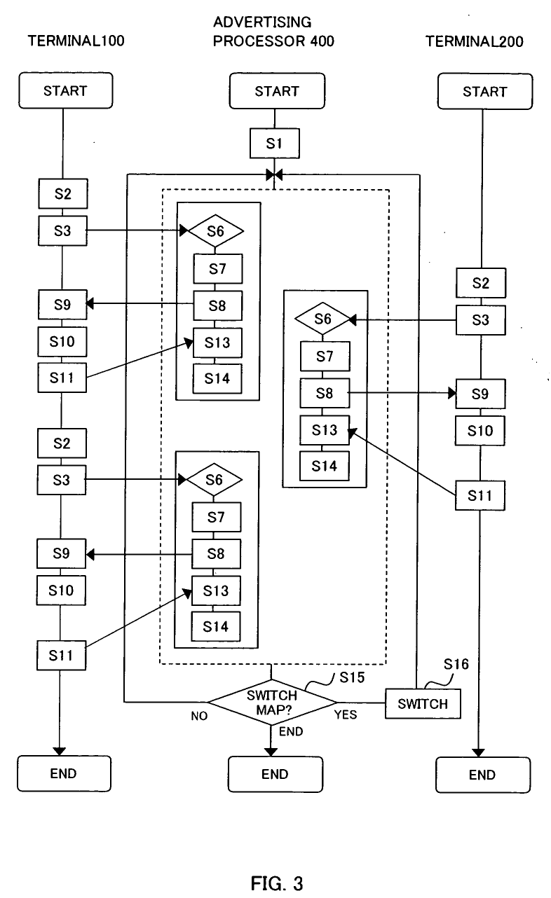

FIGS. 2 and 3 show process flows among the advertising processor 400, the banking processor 500, and the terminal 100 (200). The display device 300 is not shown in FIGS. 2 and 3 since it simply displays screen information output from the advertising processor 400.

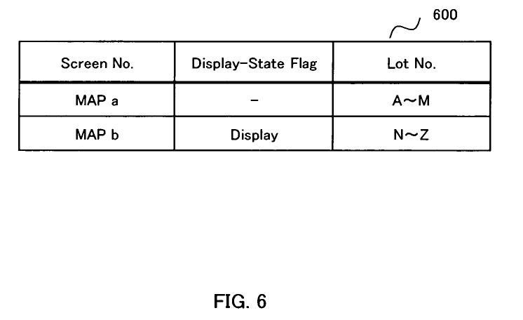

In FIG. 2, in step S1, the advertising processor 400 transmits map-screen data to the display device 300 and controls the display device 300 to display the map-screen data. In other words, the advertisement outputting program 410 arbitrarily selects map-screen data to be displayed, by referring to the screen table 600 shown in FIG. 6. The advertisement outputting program 410 extracts the map-screen data from the screen database 420 and transmits the extracted data to the display unit 310. The display unit 310 displays the transmitted data on the display device 300. At this time, a display-state flag of the screen table 600 which corresponds to the screen number of the selected screen is set to indicate “Display”. In the screen table 600, screen numbers which identify map-screen data items, display-state flags indicating whether data is being displayed, and lot numbers (or also coordinate ranges in maps may be used) are managed so as to be associated with one another.

An advertising-notification-permission flag (not shown) indicating whether advertising notification can be performed is set to indicate “PERMITTED” by the advertisement outputting program 410. When the map screen is not displayed on the display device 300, or when the advertisement outputting program 410 interrupts advertising notification processing in order to switch the map screens, the indication of the advertising-notification-permission flag is changed from “PERMITTED” to “NOT PERMITTED”.

In step S2, the depositing/withdrawing processing unit 120 (220) in the terminal 100 (200) accepts a personal number, a password, and a type of request from a user who uses the terminal 100 (200). In step S3, the depositing/withdrawing processing unit 120 (220) transmits the accepted information to the banking processor 500 together with a terminal number assigned to the terminal 100 (200), and requests the banking processor 500 to perform processing.

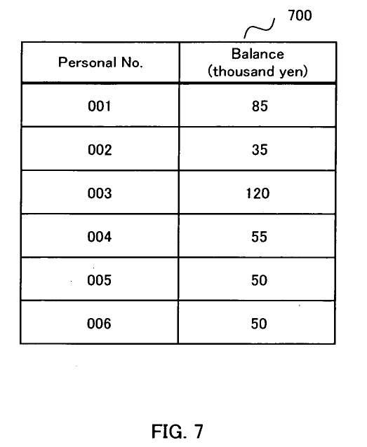

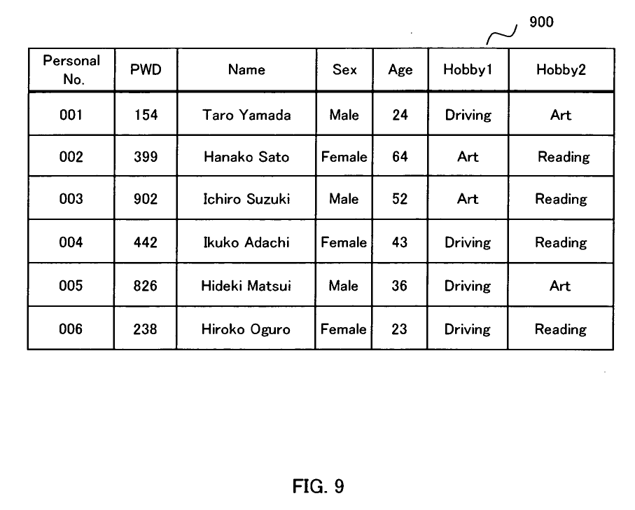

In step S4, the depositing/withdrawing management program 510 in the banking processor 500 receives the information transmitted from the terminal 100 (200), and executes banking processing concerning depositing/withdrawing, based on the personal number, the password, and the type of request in the received information. Specifically, for user authentication, by referring to the personal information table 900 shown in FIG. 9, the depositing/withdrawing management program 510 determines whether a password managed in a record corresponding to the received personal number matches the received password. If both match each other, the depositing/withdrawing management program 510 performs depositing/withdrawing processing as requested, by referring to the balance table 700 shown in FIG. 7. If both passwords do not match each other, the depositing/withdrawing management program 510 regards the state as authentication error and does not perform the depositing/withdrawing processing. A description of the depositing/withdrawing processing is omitted since it is presently performed in general.

In step S5, the depositing/withdrawing management program 510 transmits, to the terminal 100 (200), which corresponds to the terminal number received in step S4, the result of depositing/withdrawing processing, with the personal number. In addition, the depositing/withdrawing management program 510 reads, from the personal information table 900 shown in FIG. 9, user-attribute information (sex, age, hobby 1, hobby 2) in a record corresponding to the personal number of the user using the terminal 100 (200), and transmits, to the advertising processor 400, the user-attribute information, the personal number, the result of authentication, balance information, and the terminal number.

For example, the depositing/withdrawing management program 510 retrieves a record corresponding to the personal number “001” from the personal information table 900 shown in FIG. 9, and extracts “Male” as sex, “24” as age, “Driving” as hobby 1, and “Art” as hobby 2 from the record. Also, the depositing/withdrawing management program 510 extracts the balance “85 (ten thousand yen)” corresponding to the personal number “001” from the balance table 700 shown in FIG. 7.

The personal information table 900 is input beforehand based on information that users declare in registration. The hobby 1 and hobby 2 shown in FIG. 9 are fields provided when each person has a plurality of hobbies. Both may be set up to indicate priority for hobbies. Also, the number of hobby fields may be set to a value other than the number shown in FIG. 9. Alternatively, other fields may be set as user-attribute fields, and the field data may be extracted.

When the result of authentication represents error in step S4, in step S5, the depositing/withdrawing management program 510 does not need to notify the banking processor 500 and the advertising processor 400 of balance information. Also, when the result of authentication represents error, the user-attribute information is not identified, and in step S5, the depositing/withdrawing management program 510 may be prevented from notifying the advertising processor 400. In this case, the need for the next step S6 is eliminated.

In step S6, the advertisement outputting program 410 receives the information transmitted from the banking processor 500, identifies the result of authentication, and identifies the advertising-notification-permission flag described in step S1. If the result of authentication is “normal” and the permission flag indicates “PERMITTED”, the advertising processor 400 proceeds to step S7. If the result of authentication is not “normal” and the permission flag does not indicate “PERMITTED”, the advertising processor 400 proceeds to step S15 in FIG. 3.

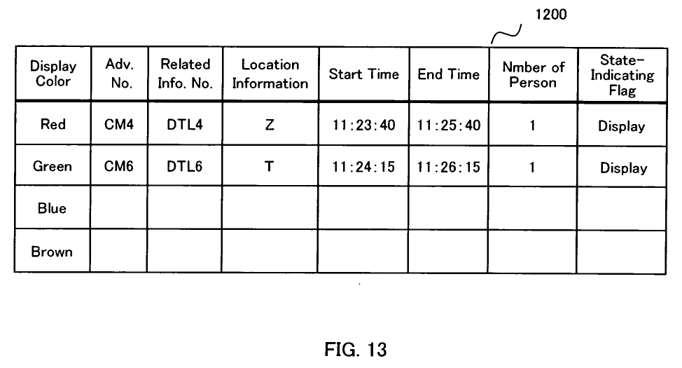

In step S7, the advertisement outputting program 410 writes the received terminal number and personal number in the terminal management table 1000. Based on the received user attribute information, the advertisement outputting program 410 selects an advertisement to be output for the personal number and the printing color of the advertisement, and stores the selections in the screen display table 1200 shown in FIG. 13. In this embodiment, it is assumed that coupons be used as advertising information printed on a balance slip. However, the advertising information is not limited to the coupons. The advertising information may have any form of information if it can be recognized as an advertisement by a user. Details of step S7 are described later.

In step S8, the advertisement outputting program 410 identifies a terminal number associated with a personal number to which the selected advertisement must be posted, by referring to the terminal management table 1000, and notifies the terminal 100 (200), which corresponds to the terminal number, of coupon data and printing color which correspond to the selected advertisement number. If a suitable advertisement is not selected in step S7, the advertisement outputting program 410 notifies the terminal 100 (200) of data indicating that there is no suitable advertisement.

In step S9, the depositing/withdrawing processing unit 120 (220) in the terminal 100 (200) creates balance-slip printing data based on the result of depositing/withdrawing processing including the balance transmitted by the banking processor 500 in step S5 and on the coupon data transmitted by the advertising processor 400.

When the result of authentication, transmitted by the banking processor 500, represents error, the depositing/withdrawing processing unit 120 (220) does not create balance-slip printing data, and terminates processing without performing the subsequent steps S10 and S11. When receiving, from the advertising processor 400, data indicating that there is no corresponding advertisement, the terminal 100 (200) creates printing data for creating only a balance slip (i.e., balance-slip printing data including no advertisement).

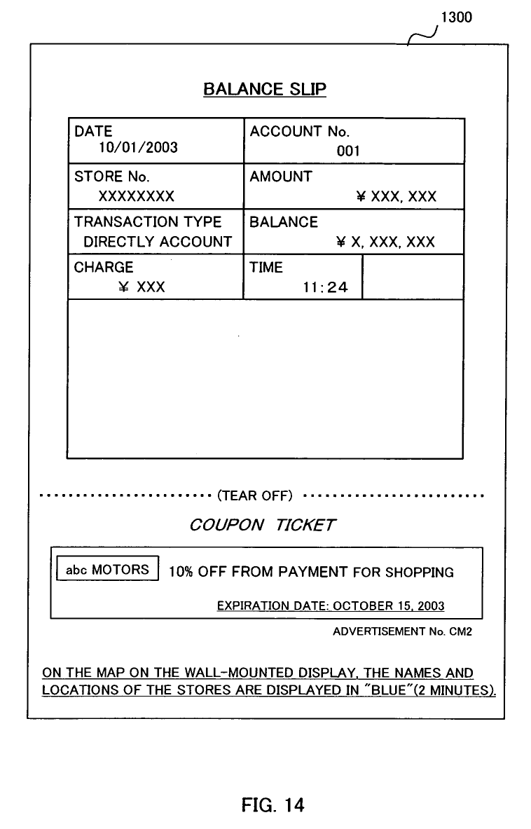

In step S10, the output unit 110 (210) in the terminal 100 (200) prints out, on the balance slip 1300 shown in FIG. 14, the coupon data and balance-slip information in the color posted from the advertising processor 400. Also, when the processing that the user commands the terminal 100 (200) to perform is withdrawing, the output unit 110 supplies necessary bills or coins.

In step S11, the output unit 110 (210) in the terminal 100 (200) transmits, to the advertising processor 400, an output-completion notification including the terminal number, the personal number, and the advertisement number, and transmits, to the banking processor 500, an output-completion notification including the terminal number and the personal number.

In step S12, the depositing/withdrawing management program 510 in the banking processor 500 receives the output-completion notification from the terminal 100 (200), and performs settlement processing that finally updates the balance table 700. In the case of depositing, the depositing/withdrawing management program 510 performs updating settlement on the balance table 700 in the banking processing in step S4 and can omit step 12.

In step S13, when the advertisement outputting program 410 in the advertising processor 400 receives the output-completion notification from the terminal 100 (200), it switches, based on the advertisement number transmitted in step S11, the indication of a display-state flag of an identical advertisement number managed in the screen display table 1200 to “Display”. It writes a time that the output-completion notification is received, as a start time, and sets a display-end time obtained by adding a predetermined time to the time of receipt.

After referring to a record including the advertisement number, the advertisement outputting program 410 transmits the information, such as the advertisement number, location information, and display color, to the display unit 310. Based on the transmitted information, the display device 300 displays the location information corresponding to the advertisement number in the designated color on an already displayed map. Then, by referring to the screen display table 1200, the advertisement outputting program 410 transmits, to the display unit 310, a related information number associated with the advertisement number, and displays, on the display device 300, the related information number in the vicinity of the location information corresponding to the advertisement number. The related information may be any type of information if it relates to coupon data printed on a balance slip, such as a store of a coupon issuer, advertising information of goods introduced in coupon data printed on a balance slip, and event information.

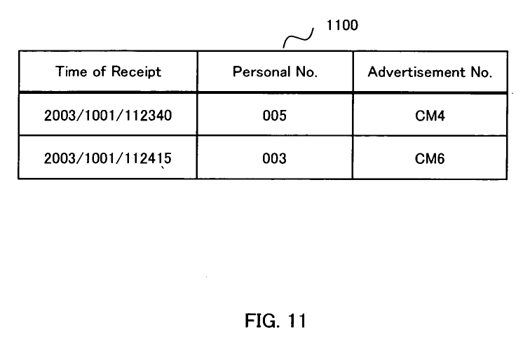

In the delivery record table 1100 shown in FIG. 11, the time of receipt of the output-completion notification, the personal number represented by the notification, and the advertisement number are written by the advertisement outputting program 410 so as to be associated with one another.

In step S14, the advertisement outputting program 410 in the advertising processor 400 performs monitoring about a screen-end time of the screen display table 1200. When the advertisement outputting program 410 finds that the present time is the screen-end time, it erases the location information and related information displayed on the map on the display device 300 by transmitting the corresponding advertisement number and a display erasing instruction to the display unit 310.

As shown in FIG. 3, the above-described steps S2 to S14 are repeated whenever the users use the terminal 100 or 200 one after another. Also, the advertising processor 400 performs processing for either terminal 100 or 200, it can perform similar processing for the other terminal. Simultaneous execution of processing for a plurality of terminals is a technology implemented in depositing/withdrawing processing in ATM terminals in the bank of the related art. Accordingly, its detailed description is omitted.

In step S15, the advertisement outputting program 410 in the advertising processor 400 determines whether to switch the map displayed on the display device 300. The map switching may be performed every predetermined time, or may be performed also when the advertisement position is not displayed on the map in the predetermined time. Alternatively, the map switching may be performed when location information of a particular advertisement or particular related information is displayed. In other words, any switching timing condition may be used if it can enhance announcing effects of a predetermined advertisement or the entire advertisement or can enhance convenience of users who view. When this condition is not satisfied, the advertisement outputting program 410 accepts a notification of the result of depositing/withdrawing processing without keeping the map screen unchanged.

When the advertisement outputting program 410 determines to switch the displayed map, based on the above condition, in step S16, an advertising-notification-permission flag (not shown) is set to represent a “not-permitted” state. The advertisement outputting program 410 is on standby until the latest time among the end times in the screen display table 1200, and then performs processing to switch the displayed map.

At this time, the advertisement outputting program 410 refers to the screen table 600 and switches, in a record whose display-state flag represents a “Display” state, the state of the display-state flag to a “Non-display” state, and switches the state of the display-state flag of a new map record to be displayed to a “Display” state. The advertisement outputting program 410 extracts and transmits, to the display unit 310 in the display device 300, map data corresponding to this screen number from the screen database 420, and displays the new map screen on the display device 300.

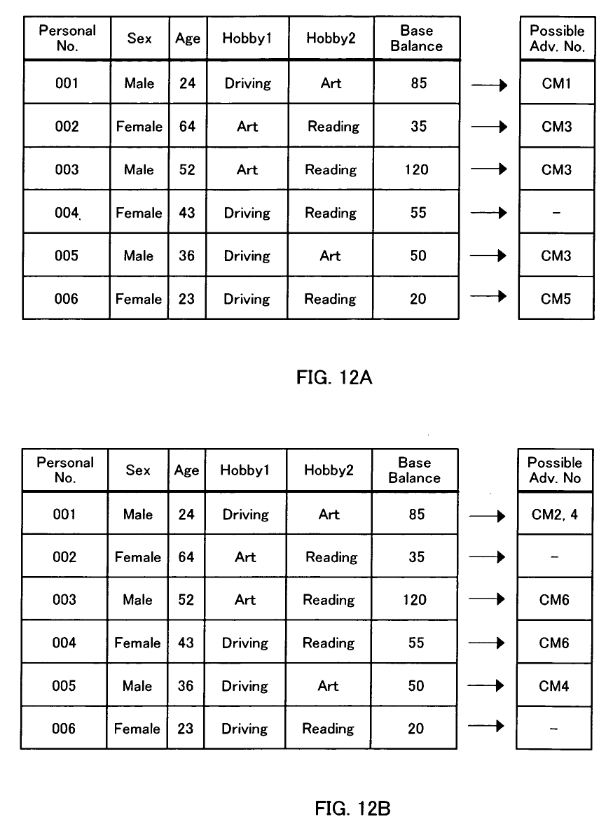

As described above, the advertising processor 400 executes the above-described consecutive processing until the banking business time or the advertisement notifying time ends. FIG. 3 does not show the part of the banking processor 500, which has already been described in FIG. 12 and which operates cooperatively.

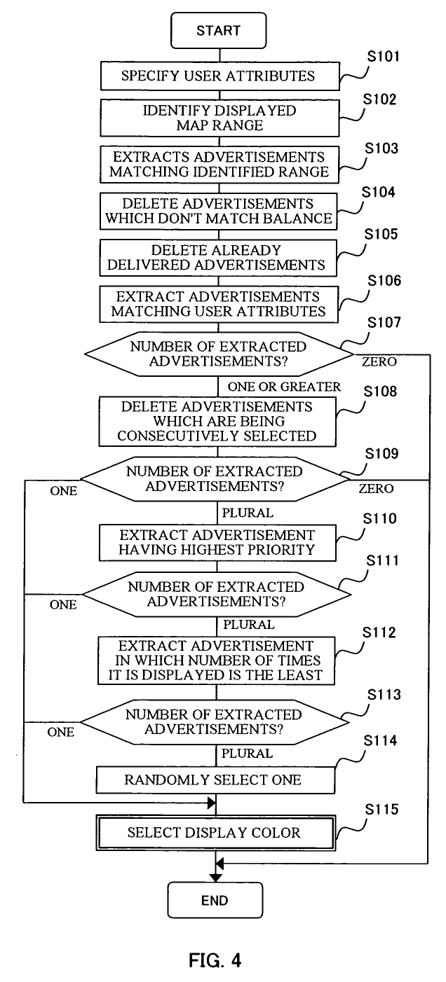

Next, a detailed processing flow (advertisement selection performed by the advertisement outputting program 410 in the advertising processor 400) of the advertisement selecting step (step S7) described with reference to FIG. 2 is described below with reference to FIG. 4.

In step S101, the advertisement outputting program 410 receives a personal number and user attributes from the banking processor 500. For example, the personal number “001”, and the user attributes, “Male” as sex, “24” as age, “Driving” as hobby 1, and “Art” as hobby 2, are received.

In step S102, in order to identify a geographic range indicated on the map displayed on the display device 300, the advertisement outputting program 410 refers to the lot-number fields of the screen table 600, and extracts lot-number data having a display-state flag representing “Display”. For example, as shown in FIG. 6, when “MAP b” is shown on the screen table 600, the data items “N to Z” in the lot number are acquired. The lot-number fields of the screen table 600 may have any form if it represents geographic positions. Also, instead of this type of address information, a coordinate range on a displayed map may be stored.

In step S103, the advertisement outputting program 410 extracts advertisement records corresponding to the acquired low numbers from the advertisement management table 800 and stores the advertisement records in a work memory in a form in which the advertisement records are associated with a personal number. In other words, for all the records of the advertisement management table 800, the advertisement outputting program 410 identifies positional fields representing geographic location information, and extracts records corresponding to the lot numbers acquired in step S102. The advertisement records extracted as described above are hereinafter referred to as the “extracted advertisement records”.

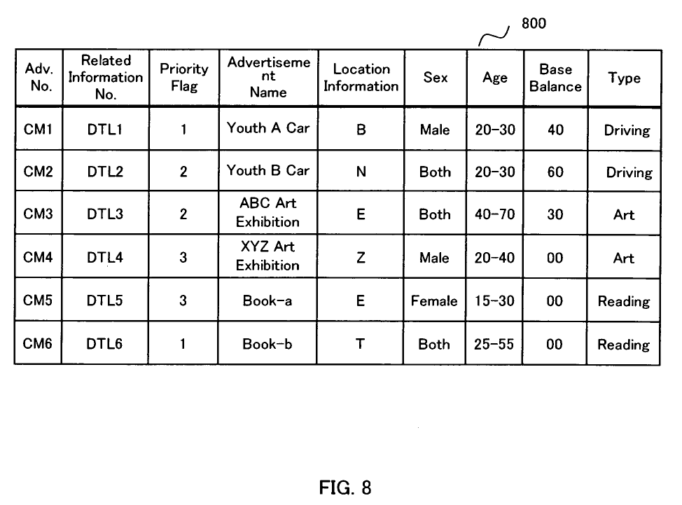

As shown in FIG. 8, the advertisement management table 800 stores advertisement numbers identifying coupon data items stored in the screen database 420, related information numbers identifying related-information-data items relating to the coupon data items stored in the screen database 420, priority flags representing priorities for selecting advertisements, advertisement names representing advertisement contents, pieces of location information representing geographic positions at which coupon information can be used, the sexes (“Male”, “female”, “both” representing males and females) of users to be notified, the ages of the users to be notified, base balances representing balances that the users to be notified must possess, and hobbies of the users to be notified. The advertisement management table 800 does not need to have a field configuration as shown in FIG. 8 if at least advertisements to be displayed, location information thereof, and attributes of the users to be notified are associated with one another.

For example, if the lot numbers “N to Z” corresponding to the screen number “MAP b” are acquired in step S102, in step S103, the advertisement outputting program 410 determines that, in the advertisement management table 800 shown in FIG. 8, the advertisement numbers “CM2” (lot number N), “CM4” (lot number Z), and “CM6” (lot number T) correspond to a map range being displayed. The advertisement outputting program 410 loads these three records into a work memory. Records extracted from the advertisement management table 800 are hereinafter referred to as “extracted advertisement records”.

By performing step S103, on one map displayed on the display device 300, pieces of location information of advertisements output to the terminals 100 and 200 can be simultaneously displayed. Accordingly, the need to switch maps displayed on the display device 300 a number of times is eliminated, and by increasing a time in which location information of an advertisement is displayed, user's convenience can be enhanced.

In step S104, the advertisement outputting program 410 compares the balance information received from the banking processor 500 and the base balance of each extracted advertisement record in the work memory, and deletes each advertisement record in which the received balance does not satisfy the base balance. For example, if records of the advertisement numbers “CM2”, “CM4”, and “CM6” are extracted in step S103, and the balance information of the record of the personal number “001” received from the banking processor 500 is “85 (thousand yen)”, the advertisement outputting program 410 compares each of the balances “60 (thousand yen)” (CM2), “00 (thousand yen)” (CM4), and “00 (thousand yen)” (CM6) of the three extracted advertisement records with the balance information “85 (thousand yen)”. Since all the base balances of the three extracted are satisfied in this case, there is no extracted advertisement records to be deleted from the work memory.

In step S105, when, the extracted advertisement records include an extracted advertisement record that has already been delivered to an identical personal number, the advertisement outputting program 410 deletes the extracted advertisement record. Specifically, by referring to the delivery record table 1100 shown in FIG. 11, the advertisement outputting program 410 searches for records of personal numbers which are being processed, and determines whether the records include the advertisement number of an advertisement record being extracted. If the advertisement number of the advertisement record is included, it is deleted by the advertisement outputting program 410. For example, if the extracted advertisement numbers for the personal number “001”, left after performing step S104, are “FCM2”, “CM4”, and “CM6”, the delivery record table 1100 does not include combinations of the corresponding personal number and the advertisement numbers. Accordingly, in step S105, there is no extracted advertisement record to be deleted by the advertisement outputting program 410.

In step S106, the advertisement outputting program 410 compares targeted user attributes in the extracted advertisement records with the user attribute information received from the banking processor 500, and leaves only extracted advertisement records which match and deletes extracted advertisement records which do not match for the work memory. Specifically, if the sex, age, and type information of each extracted advertisement record match all the fields of sex, age, and hobbies which are the attribute information received from the banking processor 500, the advertisement outputting program 410 leaves the extracted advertisement record. If not, the advertisement outputting program 410 deletes the extracted advertisement record from the work memory.

By way of example, the information received from the banking processor 500 by the advertisement outputting program 410 is the user attribute information of the user “001”, that is, the sex “Male”, the age “24”, the hobby 1 “Driving”, and the hobby 2 “Art”, and the advertisement numbers extracted in step S105 are “CM2”, “CM4”, and “CM6” (see the advertisement management table 800 in FIG. 8 for each piece of user attribute information), the advertisement number “CM6” is deleted since it does not match the user “001” in age and type, and two extracted advertisement records “CM2” and “CM4” remain.

Also, when the various tables 600, 700, 800, 900, and 1100 have the contents shown in FIGS. 6, 7, 8, 9, and 11, in the case of executing step S106 by the advertisement outputting program 410, possible advertisement numbers to be output to the personal numbers “001” to “006” are as shown in FIGS. 12A and 12B.

In step S107, the advertisement outputting program 410 determines whether there are presently extracted advertisement records left in the work memory. If the result of determination indicates even one extracted advertisement record, the advertisement outputting program 410 proceeds to step S108. If the result of determination indicates zero extracted advertisement records, there is no coupon data to be transmitted to personal numbers for which processing is presently performed, and the advertisement outputting program 410 proceeds to step S8 in FIG. 2.

In processing from step S108 to step S114, coupon data items to be transmitted are finally narrowed down to one.

In step S108, by referring to the screen display table 1200 shown in FIG. 13, the advertisement outputting program 410 determines whether the advertisement number of a record in which the number of persons concerning consecutive selection reaches the maximum number of persons is included in the extracted advertisement numbers in the work memory. The advertisement outputting program 410 deletes each extracted advertisement record whose advertisement number is included. The maximum number of persons for use in determining the number of persons who continue processing is not shown and set beforehand in the system. Depending on the circumstances, the maximum number of the persons may be fine-determined for each attribute of advertisement. Step S108 is executed in order for a particular advertisement not to be consecutively selected in not less than a certain period.

In the screen display table 1200 shown in FIG. 13, the maximum number of records which can be displayed on a single map are fixedly provided, and display color fields are provided at the beginnings of the records. In each display color field, a color in which advertisement and related information are printed and displayed is set as an initial, setting. The screen display table 1200 includes not only the display color fields but also the fields of advertisement numbers identifying coupon data items stored in the screen database 420, related information numbers concerning the coupon data items stored in the screen database 420, pieces of location information representing geographic locations, the start and end times written in step S13 in FIG. 2, the numbers of persons concerning consecutive selection, which represents the number of persons by which a single advertisement number is consecutively selected, and state-indicating flags indicating whether location information and related information are actually displayed on the display device 300. Blank spaces are stored as initial values in the above fields. Information other than the display color is written in step S115. Details of the writing are described later.

It is assumed that, in step S108, the maximum number of persons concerning consecutive selection is set to “3” and extracted advertisement records for the presently remaining personal number “001” are “CM2” and “CM4”. In the case of the screen display table 1200 having the contents shown in FIG. 13, any of the numbers of persons concerning consecutive selection does not reach “3”. Thus, a condition for the number of persons concerning consecutive selection is not satisfied, so that the extracted advertisement records of the advertisement numbers “CM2” and “CM4” remain unchanged without being deleted from the work memory.

In step S109, the advertisement outputting program 410 determines the number of the extracted advertisement records remaining in the work memory.

When the result of the determination indicates zero, there is no coupon data to be transmitted to the personal numbers for which processing is presently performed. Accordingly, the detailed advertisement selecting process ends. In FIG. 2, the advertisement outputting program 410 proceeds to step S8. When the result of the determination indicates that the number of the extracted advertisement records remaining in the work memory is one, the advertisement outputting program 410 determines that the one extracted advertisement record is an advertisement to be transmitted, and proceeds to step S115. When the advertisement outputting program 410 determines that the number of the extracted advertisement records remaining in the work memory is a plural number, the advertisements must be further narrowed down, and the advertisement outputting program 410 proceeds to step S110. For example, in step S109, if there are two extracted advertisement records “CM2” and “CM4” due to processing up to step S109, the advertisement outputting program 410 proceeds to step S110.

In step S110, the advertisement outputting program 410 compares priorities between extracted advertisement records. It leaves extracted advertisement record having a flag state representing the highest priority, and deletes the other extracted advertisement records from the work memory.

In the advertisement management table 800 shown in FIG. 8, the priority flag “1” represents the highest priority. The priority flag is set to represent a lower priority as its numeral increases. However, irrespective of this form, any form of information may be managed in this field if it can identify priority.

In step S110, when there are two extracted advertisement records “CM2” and “CM4” for the personal number “001” due to processing up to step S110, the advertisement outputting program 410 identifies the priority of each extracted advertisement record. As a result, the extracted advertisement record of the advertisement number “CM2” has the priority “2”, and the extracted advertisement record of the advertisement number “CM4” has the priority “3”. Thus, the advertisement outputting program 410 determines that the extracted advertisement record of the advertisement number “CM2” is higher in priority, and deletes the extracted advertisement record of the advertisement number “CM4”. Accordingly, only the extracted advertisement record of the advertisement number “CM2” for the personal number “001” remains.

In step S111, the advertisement outputting program 410 determines the number of the remaining extracted advertisement records in the work memory for personal numbers for which processing is presently performed.

When the result of the determination indicates one, the advertisement outputting program 410 determines that the one extracted advertisement record is to be transmitted, and proceeds to step S115. When the result of the determination indicates a plural number, the extracted advertisement records must be further narrowed down. Accordingly, the advertisement outputting program 410 proceeds to step S112.

In step S111, when there is only the extracted advertisement record of the advertisement number “CM2” due to processing up to step S111, the advertisement outputting program 410 regards the case as a state in which coupon data to be transmitted to the personal number “001” is selected, and proceeds to step S115.

In step S112, the advertisement outputting program 410 identifies the advertisement numbers of the presently remaining extracted advertisement records, and counts, for each advertisement number, the number of times the advertisement number has already been displayed which is recorded on the delivery record table 1100. The advertisement outputting program 410 leaves only an extracted advertisement record of an advertisement number in which the number of times the advertisement number has already been displayed is the least, and deletes the other extracted advertisement records.

In step S113, the advertisement outputting program 410 determines the number of the remaining extracted advertisement records in the work memory for the personal number for which processing is being performed. When the result of the determination indicates one, the advertisement outputting program 410 determines that the one extracted advertisement record is to be transmitted, and proceeds to step S115. When the result of the determination indicates a plural number, the extracted advertisement records must be further narrowed down. Accordingly, the advertisement outputting program 410 proceeds to S114.

In step S114, the advertisement outputting program 410 randomly leaves, from among the remaining extracted advertisement records, an extracted advertisement record in the work memory, and deletes the other extracted advertisement records. Alternatively, a method that finally leaves one of the extracted advertisement records by using other conditions in some stages may be employed.

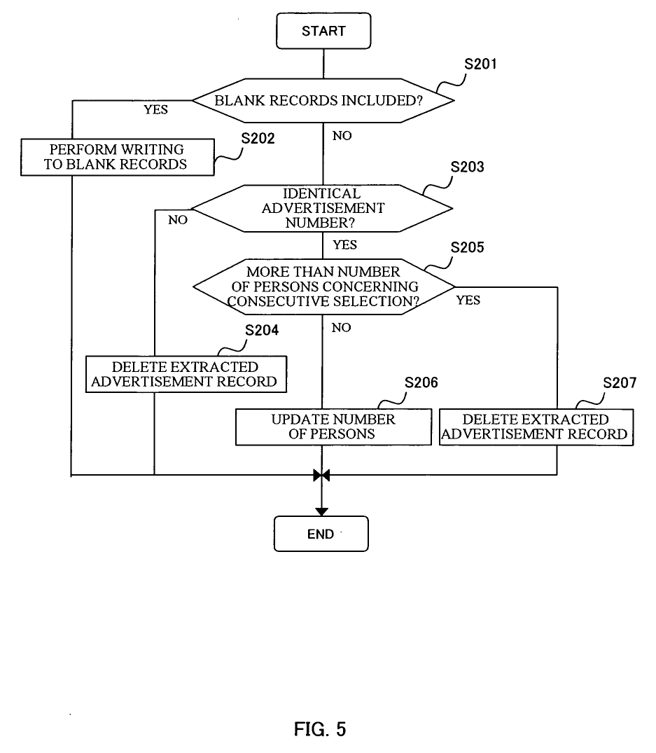

Next, in step S115, a display color is selected. A detailed process of the selection is described below with reference to FIG. 5.

In step S201, the advertisement outputting program 410 determines whether the screen display table 1200 includes blank records (records in which only display color information is stored and blank data items are record in the other fields).

When the result of the determination in step S201 indicates that the blank records are included, the advertisement outputting program 410 proceeds to step S202. In step S202, the advertisement outputting program 410 writes, in any of the blank records, the advertisement number, related information, and location information of one extracted advertisement record obtained before step S115 by narrowing down the extracted advertisement records, and writes “1” as the number of persons concerning consecutive selection. However, the start time, end time, and state-indicating flag of the record is kept unchanged. The advertisement outputting program 410 terminates the display color selecting process.

When, in step S201, the extracted advertisement record of the advertisement number “CM2” remains for the personal number “001” and the screen display table 1200 has the contents shown in FIG. 13, the advertisement outputting program 410 determines that blank records are included in the screen display table 1200. The advertisement outputting program 410 writes the advertisement number “CM2”, the related information “DTL2”, and the location information “N” of the extracted advertisement record in corresponding fields of the third record (the display color “Blue”), and sets the number of persons concerning consecutive selection to “1”.

When the result of the determination in step S201 indicates no blank records, that is, when the number of advertisements which are being displayed and which will be displayed on the map reaches the maximum number of displayed advertisements, the advertisement outputting program 410 performs processing in step S203 and thereafter. In step S203, the advertisement outputting program 410 identifies the advertisement number of each record since the screen display table 1200 includes no blank records, and determines whether some of the advertisement numbers match the advertisement numbers of the remaining extracted advertisement records in the work memory.

When the result of the determination in step S203 indicates no identical advertisement number, the advertisement outputting program 410 proceeds to step S204. In step S204, the advertisement outputting program 410 regards the display device 300 as having no room for displaying advertisement location information and related information of the extracted advertisement record, and deletes the extracted advertisement record, whereby the display color selecting process ends. As a result, there is not coupon data to be transmitted to the personal number for which processing is performed.

When the result of the determination in step S203 indicates that there is an identical advertisement number, the advertisement outputting program 410 proceeds to step S205. In step S205, the advertisement outputting program 410 determines whether the number of persons concerning consecutive selection in the record of the identical advertisement number reaches a preset maximum number of persons. Step S205 is intended for final determination of the number of persons concerning consecutive selection because, although the determination of whether the number of persons concerning consecutive selection reaches the maximum number, there is a possibility that, since processing is performed in response to parallel requests from a plurality of terminals, the number of persons concerning consecutive selection may be updated in response to a request from another terminal in a time lag up to implementation of the display color selecting process in step S115.

When the result of the determination in step S205 indicates that the number of persons concerning consecutive selection does not reaches the maximum number, the advertisement outputting program 410 adds one to the number of persons concerning consecutive selection, and terminates the display color selecting process. When the number of persons concerning consecutive selection reaches the maximum number, the advertisement outputting program 410 regards further consecutive output of coupon data of the advertisement number as improper, and deletes the extracted advertisement record before terminating the display color selecting process. As a result, there is no coupon data to be transmitted to the personal number for which processing is performed.

FIG. 14 shows an example of a balance slip 1300 obtained when the various pieces of information of the advertisement number “CM2” for the personal number “001” are set in the third record in the screen display table 1200 in FIG. 13. In this example, the personal number is used as an account number. Since the display color set in the third record in the screen display table 1200 in FIG. 13 is “Blue”, the coupon data in a bottom part of the balance slip is printed in blue, and the user is notified of also “Blue” in which data items are displayed on the display 300. In this manner, by setting the printing color of the coupon data and the display color to be identical, the user can quickly, intuitively know, among plural pieces of location information displayed on the display device 300, which pieces of information are related to the user. However, any form of information may be used if it allows the user to quickly, intuitively know correspondences among advertising information printed for the user, the location information displayed on the display device 300, and related information.

Also, referring to FIG. 14, since the distance between the start time and end time of each record in the screen display table 1200 is 2 minutes, a display time of 2 minutes is printed also on the coupon. A store which is an issuer of the coupon and an advertising statement are associated with each related information number in the screen display table 1200.

Although, in FIG. 14, the balance slip and the coupon are printed on a sheet of paper, they may be printed on separate sheets of paper.

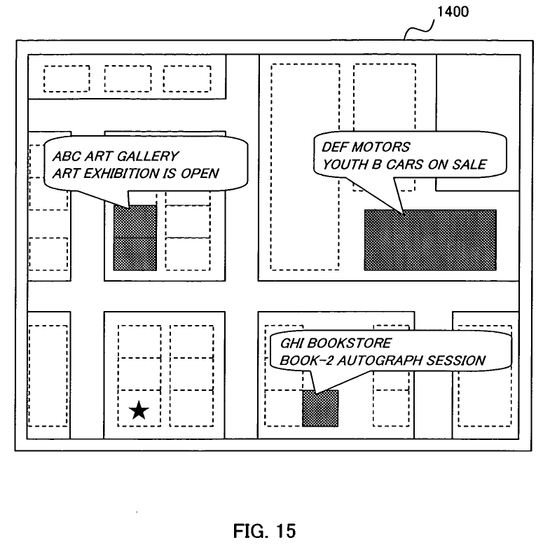

FIG. 15 shows an example of a screen (map-displayed screen 1400) displayed on the display device 300 when the various pieces of information of the advertisement number “CM2” for the personal number “001” are set in the third record in the screen display table 1200 in FIG. 13. The example in FIG. 15 shows “MAP b”. Location information and related information corresponding to data of each coupon are separately displayed in the display colors in the screen display table 1200. The asterisk symbol in the map indicates the terminal 100, which is being used by the user, and the terminal 200. This enables the user to easily have a picture of a path for the present place to places in which the printed coupon is usable.

By displaying, on the map screen, information of locations in which the coupon is usable, the minimum advantage of the present invention can be realized. However, other information may be displayed, and the displayed information is not limited to the example in FIG. 15.

Second Embodiment

In a second embodiment of the present invention, the display device 300 displays not the map but categorized display screens prepared for types of advertisement contents. Detailed advertisements matching the currently displayed categorized screens are displayed and their coupon data items are output to the terminal 100 (200).

Various tables are basically identical to those in the first embodiment, excluding the screen table 600, and the advertisement management table 800.

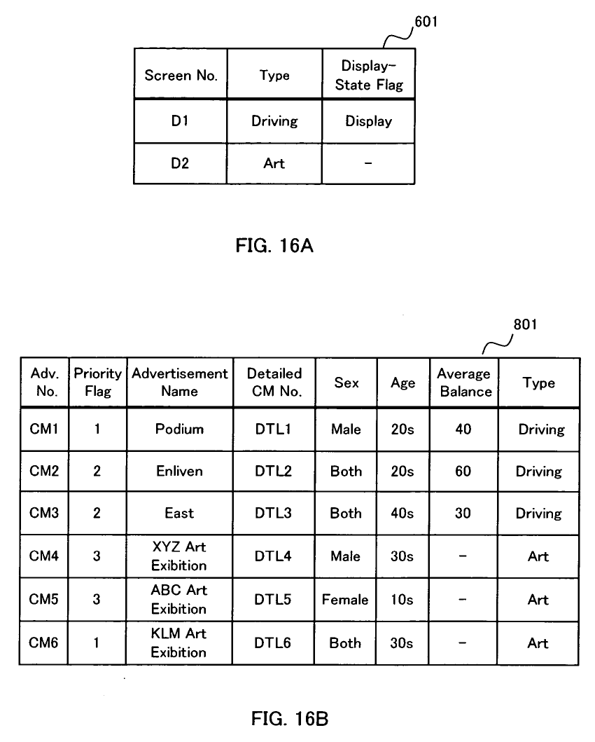

FIGS. 16A and 16B show a screen table 601 and an advertisement management table 801, respectively. The screen table 601 manages screen numbers identifying categorized display screen data items (stored in the screen database 420) prepared for types of advertisement contents to be displayed beforehand on the display device 300, types representing the contents of the screens, and display-state flags each indicating a currently-displayed state.

In the advertisement management table 801, the “Related Information No.” and “Base Balance” shown in the advertisement management table 800 in the first embodiment have been respectively changed to “Detailed CM No.” and “Average Balance”. In the “Detailed CM No.” field, for example, contents displayed on the display device 300 in a form associated with the advertisement numbers are detailed descriptions of coupon-goods covered and pieces of image information, and are stored in the screen database 420.

Regarding the “Average Balance”, the banking processor 500 stores an average balance obtained in a predetermined period in the balance table 700, which represents the latest account balance, and transmits this information to the advertising processor 400. In the advertising processor 400, the advertisement outputting program 410 determines, in step S104, whether the average balance matches an average balance condition of users to be notified in the advertisement management table 800.

In the advertisement selecting process, in step S102, the advertisement outputting program 410 uses the screen table 601 to identify the type of screen data displayed on the display device 300. In step S103, the advertisement outputting program 410 loads, into the work memory, advertisement records which have types of users to be notified and which match the type of screen data currently displayed. For example, in the screen table 601, the type of screen in which the display-state flag is “Display” is “Driving”. Accordingly, the advertisement outputting program 410 loads, into the work memory, advertisement records which have “Driving” in the type fields in the advertisement management table 801.

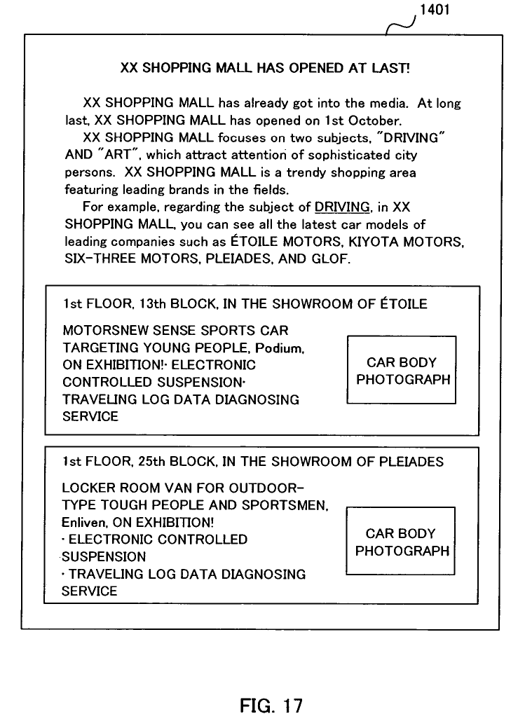

After that, in steps other the already described step S104, by performing processing similar to that in the first embodiment, the advertisement outputting program 410 selects an advertisement to be transmitted. The result of the selection allows the display device 300 to display the categorized display screen 1401 shown in FIG. 17.

On the categorized display screen 1401, portions describing “Sports Car Podium” and “Locker Room Van Enliven” correspond to the detailed commercial screen data displayed corresponding to the coupon data output to the terminal 100 (200). Accordingly, if the coupon data to be output is not the “Podium” but the “East” in the third record in the advertisement management table 801, the corresponding portion on the categorized display screen 1401 changes into information concerning the “East”.

Also, as screen data displayed beforehand, screen data of the “Art” in the second record in the screen table 601 is displayed. For the “Art” screen, for example, a screen in which an advertising statement after “For example” is directed to information of “Art” may be used.

A printed balance slip corresponding to the above case is similar to that in the first embodiment. In the second embodiment, categories of advertisement are used for classification. However, other types of attributes concerning advertisement, or any types of attributes of users to be notified of advertisement may be employed for classification.

As described above, in the present invention, not only pieces of location information which correspond to advertising information output to identical maps displayed by terminals can be displayed, but also pieces of detailed related information which correspond to pieces of single-category coupon information output to the terminals can be displayed on common screens for notifying users of a particular category or topic.

Third Embodiment

In a third embodiment of the present invention, the screen displayed on the display device 300 is not a categorized display screen but a floor guidance screen concerning the floors of a single building. Detailed advertisement matching the floor guidance screen is displayed and its coupon data is output to the terminal 100 (200).

Various tables in the third embodiment are basically identical in configuration to those in the second embodiment, excluding the screen table 601, and the advertisement management table 801.

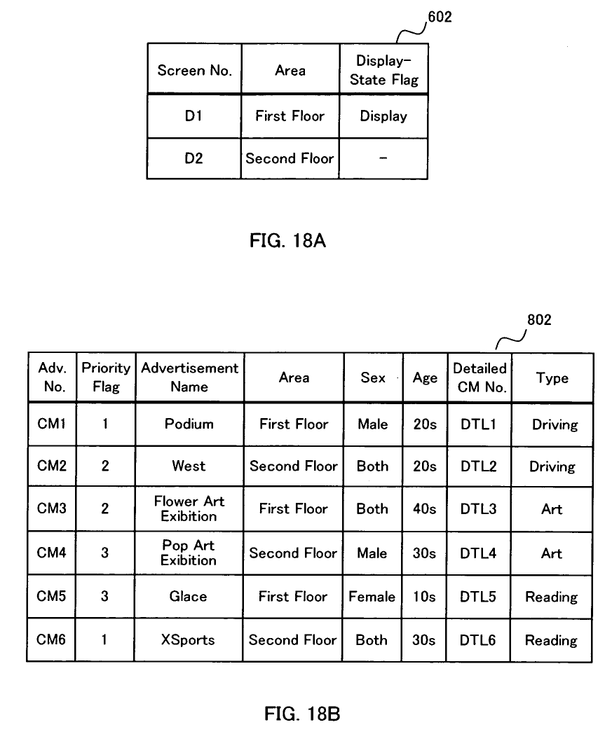

FIG. 18 shows a screen table 602 and an advertisement management table 802. The screen table 602 is such that the “Type” representing advertisement content in the screen table 601 in the second embodiment is changed into the “Area” field representing floor numbers.

In the advertisement management table 802, instead of the “Average Balance” in the advertisement management table 801 in the second embodiment, the “Area” field representing floor numbers is managed. Here, since average balance information is not used as a user attribute, in step S5 in FIG. 2, the banking processor 500 does not transmit an average balance to the advertising processor 400.

In step S102 in the advertisement selecting process, the advertisement outputting program 410 acquires the floor number of a currently displayed floor by referring to the screen table 602. In step S103, by referring to the advertisement management table 802, the advertisement outputting program 410 loads, into the work memory, an advertisement record matching the acquired floor number.

A displayed screen may be basically identical in configuration to the categorized display screen 1401 in the second embodiment. Specifically, information above the detailed commercial information on the screen may be replaced by a description of a particular floor in the building.

In the third embodiment, data items in the “Area” field are classified for each floor in the building. However, the classification is not limited to units of floors, but units of regions obtained by two-dimensionally dividing the building site may be used for classification, and any type of spatial classification may be employed.

As described above, not only pieces of location information which correspond to pieces of advertising information on identical maps displayed by terminals, but also goods in the advertisement and store details can be displayed as general advertising information on the display device 300.

1. A method for providing information to a plurality of terminal devices and a display device, comprising:
a reception step of receiving terminal identifying information and user identifying information from the plurality of terminal devices;
an identification step of identifying an attribute of a user corresponding to the received user identifying information by referring to a user management table defining association between the user identifying information and the attribute of a user;
an information extraction step of extracting information to be provided and related information corresponding to the identified attribute of a user by referring to a information management table defining association among the attribute of a user, the information to be provided and the related information; and
an output step of outputting the information to be provided to the terminal device and displaying the related information on the display device.

2. A method for providing information according to claim 1, wherein the information to be provided extracted by the extraction step is narrowed down by using assumption information displayed beforehand on the display device as a search key.

3. A method for providing information according to claim 2, wherein the information to be provided is advertising information or incentive information,
the related information is locational information,
the assumption information is map information,
the information to be provided extracted by the extraction step is narrowed down to that having locational information indicative of location within the area of the map displayed beforehand on the display device based on the map information, and
the output step is outputting the information to be provided to the terminal device and displaying locational information of the extracted information on the map on the display device.

4. A method for providing information according to claim 2, wherein the information to be provided is advertising information or incentive information,
the related information is locational information, and
the information to be provided extracted by the extraction step is narrowed down to that having locational information indicative of location within the area of the specific region displayed beforehand on the display device based on the specific regional information.

5. A method for providing information according to claim 2, wherein the information to be provided is advertising information or incentive information,
the assumption information is specific advertising category information, and
the information to be provided extracted by the extraction step is narrowed down to that corresponding the specific advertising category displayed beforehand on the display device based on the specific advertising category information.

6. A method for providing information according to claim 1, wherein the output step is displaying more than one piece of related information among the extracted related information, all at once on the display device.

7. A method for providing information according to claim 1, wherein the information to be provided extracted by the extraction step is narrowed down to that based on result comparing prepared bank account with user bank account corresponding the received user identifying information by referring to a money management table defining association between the user identifying information and the user bank account.

8. An apparatus for providing information to a plurality of terminal devices and a display device, comprising:
a reception means for receiving terminal identifying information and user identifying information from the plurality of terminal devices;
an identification means for identifying an attribute of a user corresponding to the received user identifying information by referring to a user management table defining association between the user identifying information and the attribute of a user;
an information extraction means for extracting information to be provided and related information corresponding to the identified attribute of a user by referring to a information management table defining association among the attribute of a user, the information to be provided and the related information; and
an output means for outputting the information to be provided to the terminal device and displaying related information on the display device.

9. A apparatus for providing information according to claim 8, wherein the information to be provided extracted by the extraction means is narrowed down by using assumption information displayed beforehand on the display device as a search key.

10. An apparatus for providing information according to claim 9, wherein the information to be provided is advertising information or incentive information,
the related information is locational information,
the assumption information is map information,
the information to be provided extracted by the extraction means is narrowed down to that having locational information indicative of location within the area of the map displayed beforehand on the display device based on the map information, and
the output means is outputting the information to be provided to the terminal device and displaying locational information of the extracted information on the map on the display device.

11. An apparatus for providing information according to claim 8, wherein the output means is displaying more than one piece of related information among the extracted related information, all at once on the display device.

12. A computer-readable medium encoded with a program for providing information to a plurality of terminal devices and a display device when executed by a computer, the program causing the computer to perform a process comprising:
a reception step of receiving terminal identifying information and user identifying information from the plurality of terminal devices;
an identification step of identifying an attribute of a user corresponding to the received user identifying information by referring to a user management table defining association between the user identifying information and the attribute of a user;
an information extraction step of extracting information to be provided and related information corresponding to the identified attribute of a user by referring to a information management table defining association among the attribute of a user, the information to be provided and the related information; and
an output step of outputting the information to be provided to the terminal device and displaying the related information on the display device.

13. A computer-readable medium encoded with a program according to claim 12, wherein the information to be provided extracted by the extraction step is narrowed down by using assumption information displayed beforehand on the display device as a search key.

14. A computer-readable medium encoded with a program according to claim 13, wherein the information to be provided is advertising information or incentive information,
the related information is locational information,
the assumption information is map information,
the information to be provided extracted by the extraction step is narrowed down to that having locational information indicative of location within the area of the map displayed beforehand on the display device based on the map information, and
the output step is outputting the information to be provided to the terminal device and displaying locational information of the extracted information on the map on the display device.

15. A computer-readable medium encoded with a program according to claim 12, wherein the output step is displaying more than one piece of related information among the extracted related information, all at once on the display device.
